(19) United States
(12) Patent Application Publication
(10) Pub. No.: US 2014/0236987 A1
(43) Pub. Date: Aug. 21, 2014

(54) SYSTEM AND METHOD FOR AUDIO SIGNAL COLLECTION AND PROCESSING

(71) Applicant: Tencent Technology (Shenzhen) Company Limited, Shenzhen (CN)

(72) Inventor: Xueliang LIU, Shenzhen (CN)

(73) Assignee: Tencent Technology (Shenzhen) Company Limited, Shenzhen (CN)

(21) Appl. No.: 14/260,990

(22) Filed: Apr. 24, 2014

Related U.S. Application Data
(63) Continuation of application No. PCT/CN2013/088037, filed on Nov. 28, 2013.

(30) Foreign Application Priority Data
Feb. 1, 2013 (CN) 201310040998.3

(51) Int. Cl. G06F 17/30

(52) U.S. Cl. CPC G06F 17/30755
USPC 707/769

(57) ABSTRACT

The present application discloses systems and methods that may be used for audio signal collection and processing. After receiving audio data by recording or transmission, a computer system may process the audio data to generate audio metadata associated with the audio data. An audio signal collection agent module and an agent portal may be used to collect and distribute the audio data and audio metadata by using a data queue of a fixed length. The length of the data queue is maintained to optimize processing speed. The data in the data queue is processed by a data processing module such that the audio metadata is stored in a database and the audio data is stored in files within a file system. In response to a search query, a file including audio data associated with the matched audio metadata may be quickly identified.

### RELATED APPLICATIONS

This application is a continuation application of PCT Patent Application No. PCT/CN2013/088037, entitled “SYSTEM AND METHOD FOR AUDIO SIGNAL COLLECTION AND PROCESSING” filed Nov. 28, 2013, which claims priority to Chinese Patent Application No. 201310040998.3, “System and Method for Audio Signal Collection and Processing,” filed Feb. 1, 2013, both of which are hereby incorporated by reference in their entirety.

### FIELD OF THE INVENTION

The present application relates to the field of audio signal processing, and in particular to a system and method for audio signal collection and processing.

### BACKGROUND OF THE INVENTION

The conventional log-based audio collection system usually adopts a two-layer processing framework. In particular, the collection device in the collection layer (generally audio signal processing unit) processes and records the audio signal, which is usually on-line data, such as audio data from the speech recognition cloud services. Thereafter, the collection device sends the recorded audio signals to the data processing server in the storage management layer in accordance with preset rules so as to complete the collection of audio data.

Thus, it is clear that in the conventional log-based audio collection system, the processing and collection of audio signals are all conducted with the collection device. In general, such an approach leads to increases in complexity and maintenance difficulty of the collection device. Moreover, the collection of audio signals will prolong the response time of the collection device, resulting in service quality degradation of the audio collection system.

Accordingly, it is necessary and desirable to provide a new technology, so as to resolve the technical problem and improve the above-mentioned approach.

### SUMMARY

The above deficiencies and other problems associated with audio encoding and transmission are reduced or eliminated by the invention disclosed below. In some embodiments, the invention is implemented in a computer system that has one or more processors, memory and one or more modules, programs or sets of instructions stored in the memory for performing multiple functions. Instructions for performing these functions may be included in a computer program product configured for execution by one or more processors.

One aspect of the invention involves a computer-implemented method performed by a computer system. The computer system may receive audio data using an audio signal collection module and process the audio data to generate audio metadata associated with the audio data. The computer system may also transmit the audio data and the audio metadata to an audio signal collection agent module, wherein the audio signal collection agent module is configured to generate a data queue of a fixed length using the audio data and the audio metadata by dropping data exceeding the fixed length. The data in the data queue may be processed by the computer system using a data processing module such that the audio metadata is stored in a database and the audio data is stored in files within a file system separate from the database, wherein, in response to a search query, audio metadata in the database is checked for matching the search query and if a match is found in the database, a file including audio data associated with the matched audio metadata is identified.

Another aspect of the invention involves a computer system. The computer system may comprise one or more processors, memory, and one or more program modules stored in the memory and configured for execution by the one or more processors, the one or more program modules including: an audio signal collection module configured to: receive audio data, process the audio data to generate audio metadata associated with the audio data, and transmit the audio data and the audio metadata; an audio signal collection agent module configured to: receive the audio data and the audio metadata, and generate a data queue of a fixed length using the audio data and the audio metadata by dropping data exceeding the fixed length; and a data processing module configured to process the data queue such that the audio metadata is stored in a database and the audio data is stored in files within a file system separate from the database, wherein, in response to a search query, audio metadata in the database is checked for matching the search query and if a match is found in the database, a file including audio data associated with the matched audio metadata is identified.

Another aspect of the invention involves a non-transitory computer readable storage medium having stored therein instructions, which, when executed by a computer system, cause the computer system to: receive audio data using an audio signal collection module; process the audio data to generate audio metadata associated with the audio data; transmit the audio data and the audio metadata to an audio signal collection agent module, wherein the audio signal collection agent module is configured to generate a data queue of a fixed length using the audio data and the audio metadata by dropping data exceeding the fixed length; and process the data queue using a data processing module such that the audio metadata is stored in a database and the audio data is stored in files within a file system separate from the database, wherein, in response to a search query, audio metadata in the database is checked for matching the search query and if a match is found in the database, a file including audio data associated with the matched audio metadata is identified.

Some embodiments may be implemented on one or more computer devices in a network environment.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a block diagram illustrative of a computer system comprising modules configured to collect and process audio signals in accordance with some embodiments of the present application.

FIG. 2 is a block diagram illustrative of a computer system comprising modules configured to collect and process audio signals in accordance with some embodiments of the present application, providing more details.

FIG. 3 is a block diagram illustrative of functional units in an audio signal collection agent module in accordance with some embodiments of the present application.

FIG. 4 is a block diagram illustrative of functional unit in a data processing module in accordance with some embodiments of the present application.

FIG. 5 is a flowchart illustrative of a method for audio collection and processing by a computer system in accordance with some embodiments of the present application.

FIG. 6 is a flowchart illustrative of a method for audio collection and processing by a computer system in accordance with some embodiments of the present application, providing more details.

FIG. 7 is a block diagram of a computer system in accordance with some embodiments of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

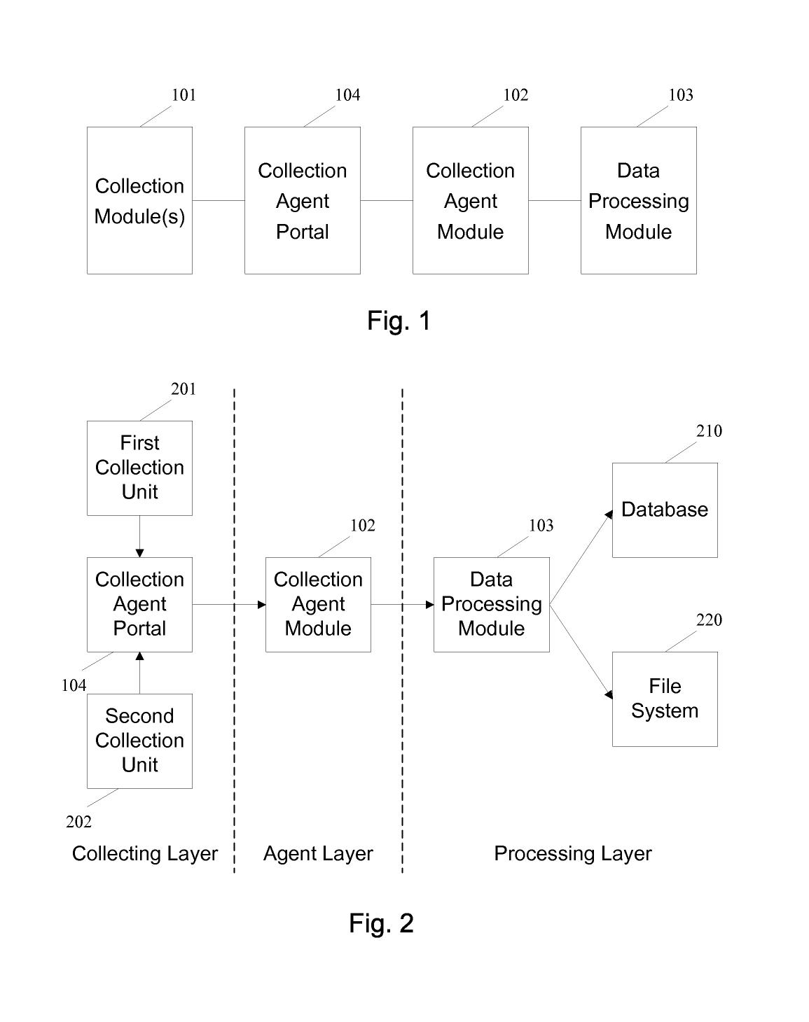

FIG. 1 is a block diagram illustrative of a computer system comprising modules configured to collect and process audio signals in accordance with some embodiments of the present application. The computer system may comprise one or more processors; memory; and one or more programs modules stored in the memory and configured for execution by the one or more processors. As shown in FIG. 1, the one or more program modules may include: one or more audio signal collection modules 101, an audio signal collection agent module 102, a collection agent portal 104, and a data processing module 103. The computer system may be any computing device that has data processing capabilities, such as but not limited to: servers, workstations, personal computers such as laptops and desktops, and mobile devices such as smart phones and tablet computers. The computer system may also include multiple computing devices functionally integrated to collect and process audio signals.

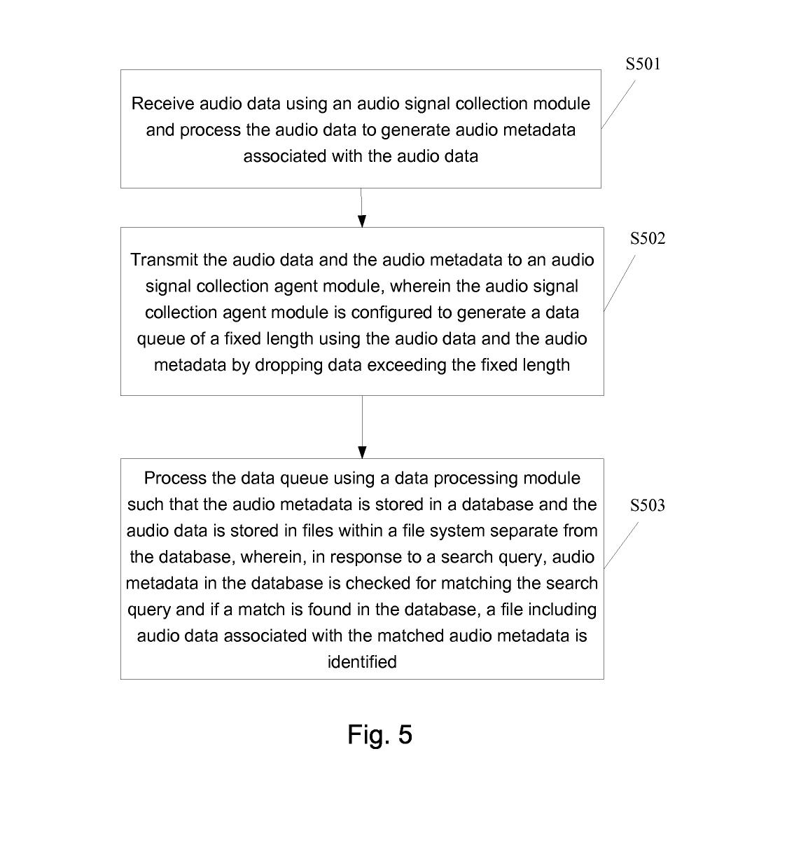

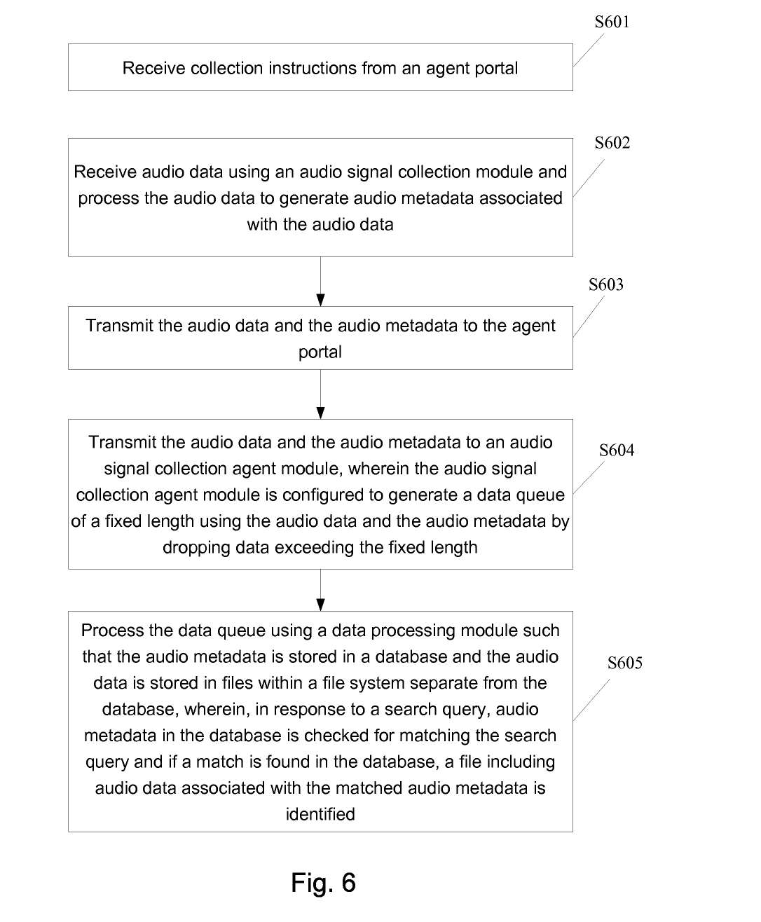

FIG. 5 is a flowchart illustrative of a method for audio collection and processing by a computer system in accordance with some embodiments of the present application. FIG. 6 is a flowchart illustrative of a method for audio collection and processing by a computer system in accordance with some embodiments of the present application, providing more details. FIGS. 5 and 6 show that the modules in FIG. 1 may function, interact, and communicate to collect and process audio signals, optimizing the management of audio data and facilitating the search of audio data.

Referring to FIGS. 1, 5, and 6, as shown in step S501 of FIG. 5 and step S602 of FIG. 6, the computer system may receive audio data using an audio signal collection module 101 and process the audio data to generate audio metadata associated with the audio data. The audio signal collection module 101 is configured to receive the audio data, which may be converted from original audio signals, e.g. sound recordings, or transmitted from other sources, e.g. the internet. The audio data may be received in any format encoding audio as well as other signals. The audio signal collection module 101 may include functioning units that may carry out different tasks but generally serve to collect and process audio data. In some embodiments, the audio signal collection module 101 may be configured to process the audio data to generate audio metadata associated with the audio data. The audio metadata may include information items such as but not limited to: audio encoding format, audio encoding codec, data storage mode, data sampling rate, data size, file size and format, collection time, and any other information related to the collection, processing, source, and/or content of the audio data.

Referring to FIGS. 1 and 6, as shown by step S601 of FIG. 6, before the audio signal collection module 101 receives the audio data, the audio signal collection module 101 may receive collection instructions from an audio signal collection agent portal 104. The agent portal 104 may facilitate and manage the collection and processing of audio signals and/or transmission of the audio data and audio metadata by the audio signal collection module 101. The collection instructions may include but not limited to: address information of an audio signal collection agent module 102, collection ratio for the audio data, and category information of the audio data and audio metadata. The agent portal 104 is an optional functional module that may be configured to carry out other function. The agent portal 104 may also be omitted in some embodiments and its functions may be provided by other modules.

Referring to FIGS. 1, 5, and 6, as shown by step S502 of FIG. 5 and step S604 of FIG. 6, the computer system may transmit the audio data and the audio metadata to an audio signal collection agent module 102. In some embodiments, the audio signal collection module 101 is configured to send the audio data and audio metadata to the audio signal collection agent module 102 directly. Alternatively, in some embodiments, as shown by steps S603 and S604 of FIG. 6, the audio signal collection module 101 may send the audio data and the audio metadata to the audio signal collection agent portal 104, wherein the agent portal 104 may distribute the audio data and audio metadata to the audio signal collection agent module 102. The transmission of audio data and audio metadata may involve further formatting and encapsulation. The embodiments are shown in the examples below.

Referring to FIGS. 1, 5, and 6, in some embodiments, the audio signal collection agent module 102 may be configured to generate a data queue using the audio data and the audio metadata. The data queue may be formed and formatted in any manner. For example, the audio data and the audio metadata may be transmitted in the order of a receiving time succession of the audio data by the collection agent module 101, and the data queue may be formed based on the receiving time succession.

The length (size) of the data queue may be fixed or may vary, based on the setup of the audio signal collection agent module 102. In some embodiments, the data queue has a fixed length—the amount of data stored in the data queue does not exceed a certain threshold. In some embodiments, to maintain the fixed length, the audio signal collection agent module 102 may drop data exceeding the fixed length by rejecting data transmitted to the audio signal collection agent module 102. Alternatively, the audio signal collection agent module 102 may drop data by discarding data already in the data queue to make the overall length of the data queue within the fixed length.

Referring to FIGS. 1, 5, and 6, as shown by step S503 of FIG. 5 and step S604 of FIG. 6, the computer system may process the data queue using a data processing module 103. The data processing module 103 is configured to process the audio data and audio metadata in the data queue. In some embodiments, the audio data and audio metadata are processed directly. In some embodiments, the audio data and audio metadata are sent from the audio signal collection agent module 102 to the data processing module 103 before being processed. To maintain the fixed length of the data queue, the audio signal collection agent module 102 may delete the audio data and audio metadata that have been sent to the data processing module 103.

The data processing module 103 may be configured to process the audio data and audio metadata so that the audio metadata is stored in a database and the audio data is stored in files within a file system separate from the database. In some embodiments, in response to a search query, audio metadata in the database is checked for matching the search query and if a match is found in the database, a file including audio data associated with the matched audio metadata is identified. Such an approach may make data processing and management more convenient, develop system efficiency, and improve system security.

### EXAMPLE 1

FIG. 2 is a block diagram illustrative of a computer system comprising modules configured to collect and process audio signals in accordance with some embodiments of the present application, providing more details for the structure of the computer system. FIG. 2 shows that the computer system may include three layers: the collecting layers, the agent layer, and the processing layer. The collecting layer may include an audio signal collection agent portal 104 and an audio signal collection module, which may comprise a first collection unit 201 and a second collection unit 202. Since the agent portal 104 may include multiple types of connectors and/or portals at the same time, the agent portal 104 may also be called an agent interface library (AgentLib). The agent layer may include the audio signal collection agent module 102. The processing layer may include the data processing module 103, which is connected to a database such as but not limited to a Mysql database, and a file system such as but not limited to an NFS file system.

In the collecting layer, the first collection unit 201 and the second collection unit 202 are examples of collection units in the audio signal collection module and such units may be used to collect and receive audio data and process the audio data to generate audio metadata. The first collection unit 201 and the second collection unit 202 may carry out similar or different functions. For example, the first collection unit 201 may be used to receive audio data based on recorded audio signals; the second collection unit 202 may be used to process the audio data to generate audio metadata. The sources of the audio data may vary, as indicated above. The AgentLib may be used to send the audio data and audio metadata to the audio signal collection agent module 102, clarifying the functions and interactions of the audio collecting end and the processing modules.

The audio signal collection agent module 102 may be used to distribute the audio data and audio metadata from the collecting layer. Moreover, the audio signal collection agent module 102 may be used to control the collection speed of the collecting layer. When the collection speed is too high, the audio signal collection agent module 102 may drop, discard, and/or reject data to reduce the possible influence on audio data collection and processing.

The processing layer may be used to process and store the audio data and audio metadata. In some embodiments, the audio metadata is stored in a database 210 such as a Mysql database; the audio data is stored in a file system 220 such as the NFS file systems, wherein the metadata and the audio data are connected, e.g. through file path information. The data processing module 103 may include different processing units that may process different data/metadata. When the default processing units cannot meet the requirements of the audio data and audio metadata, other processing units may also be used, providing complete processing power.

### EXAMPLE 2

As indicated above, the agent portal 104 may be an agent interface library AgentLib, which is positioned between the audio signal collection module and the audio signal collection agent module. The AgentLib may include two types of units: the first one is a data transmission unit; the second is a configuration unit. The data transmission unit may be used by the audio signal collection module to transmit the audio data and audio metadata to the audio signal collection agent module. The configuration unit may be used to control audio data collection. The configuration unit may use collection instructions to control the audio signal collection module, wherein the collection instructions may include information items such as but not limited to: address information of the audio signal collection agent module, collection ratio for the audio data, and category information of the audio data.

In order to reduce the impact on the audio signal collection module, in some embodiments, the audio signal collection agent module and the audio signal collection module may be deployed in the same server. In some embodiments, the AgentLib may quickly send the audio data and audio metadata to audio signal collection agent module through domain sockets.

Generally, the audio data and audio metadata are structured. Through open source protobuf, the serialization and deserialization for the audio data and/or audio metadata may be conducted.

The AgentLib and the audio signal collection agent module may send/receive audio data and audio metadata using predefined communication protocols. The AgentLib may use the protocols to encapsulate the audio data and audio metadata before sending the data to the audio signal collection agent module.

The communication protocols may include a number of rules. For example, the communication protocol may specify that the encapsulated audio data and audio metadata should be configured as: data type field (four-byte integral type)+data length field (four-byte integral type)+protobuf serializable audio data and audio metadata.

The encapsulation may be carried out by the AgentLib automatically, simplifying the process of utilizing the portals. Alternatively, the encapsulation may require a prompt-acknowledge step. In addition, in some embodiments, when the audio signal collection process is simplified, the AgentLib may be integrated into the audio signal collection module.

### EXAMPLE 3

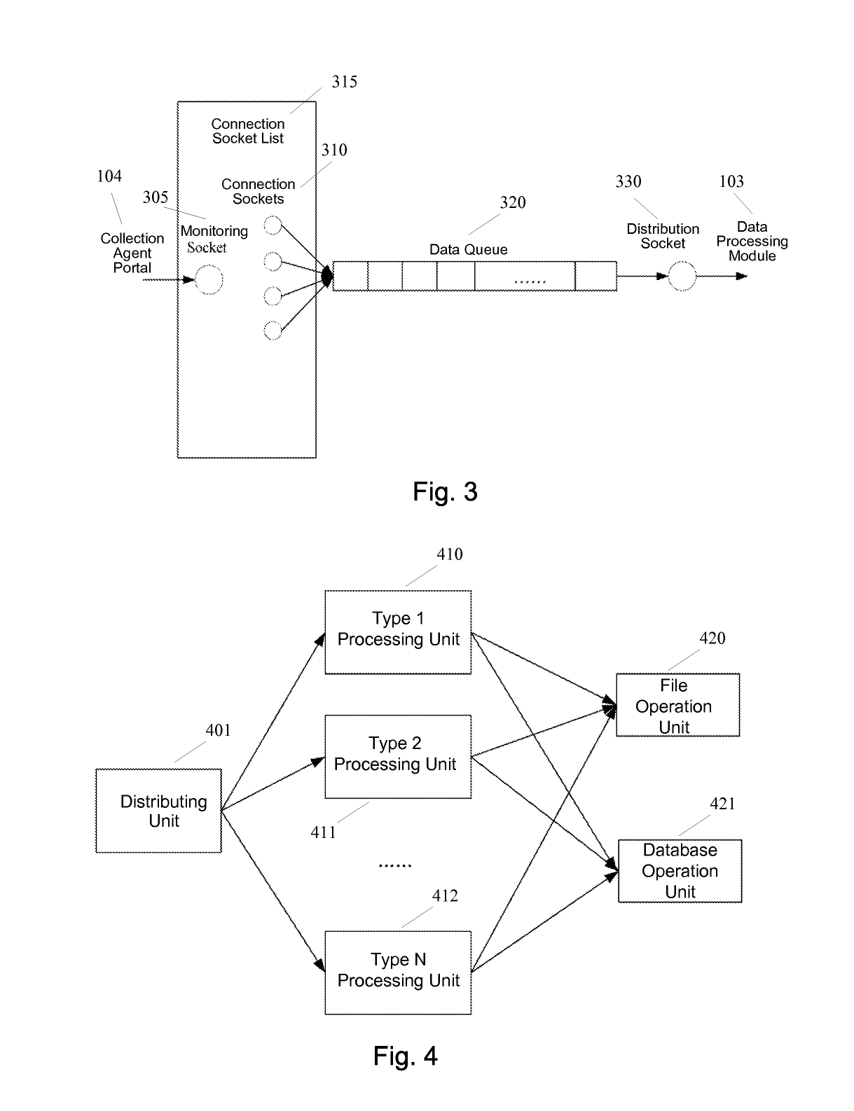

FIG. 3 is a block diagram illustrative of functional units in an audio signal collection agent module in accordance with some embodiments of the present application. The audio signal collection agent module (Agent) may use non-blocking monitoring socket in the connection to the audio signal collection agent portal (AgentLib). The monitoring sockets may be used to monitor the connection of multiple AgentLibs simultaneously. In addition, such an approach makes it possible for the Agent to receive audio data and audio metadata from multiple AgentLibs.

As shown in FIG. 3, the monitoring sockets 305 of the Agent may be used to monitor the connection sockets 310 from the AgentLib. In addition, the Agent may add the monitored connection sockets 310 to the connection socket list 315, detecting the incoming encapsulated audio data and audio metadata.

When the encapsulated audio data and audio metadata arrive, the Agent may be used to insert the audio data and audio metadata to the data queue 320. When the data queue 320 is not empty, the distribution socket 330 connected to the data processing module 103 may be used to send the audio data and audio metadata from the audio signal collection agent module to the data processing module 104 for processing. To improve efficiency, in some embodiments, the data queue 320 is a fixed length data queue. The Agent may maintain the fixed length data queue by dropping data exceeding the fixed length, preventing and/or reducing the wait time of the data processing module.

### EXAMPLE 4

FIG. 4 is a block diagram illustrative of functional unit in a data processing module in accordance with some embodiments of the present application. The data processing module may include a distribution unit 401 and one or more processing units, such as the type 1 processing unit 410, the type 2 processing unit 411, and the type N processing unit 412. Each processing unit may be used to process a different type of data. In addition, the data processing module may include a file operation unit 420 and a database operation unit 421, which may be accessed by the other processing units.

The data processing module may adopt a plug-in framework for implementation. By implementing new plug-ins and adding the plug-ins to the configuration file, the audio collection and management process may be conveniently expanded.

When the audio signal collection process is started, the distributing unit 401 of the data processing module may utilize the configuration file and load the plug-ins defined in the configuration. After receiving the encapsulated audio data and audio metadata, the distributing unit 401 may distribute the different types of the data to the corresponding processing units, e.g. type 1 processing unit 410, type 2 processing unit 411, and type N processing unit 412.

The data processing module may implement the processing units corresponding to several common collection scenarios as default in advance to meet the regular audio collection demand. In the cases of special collection demands, the data processing module may flexibly define new protobuf protocols for the processing units and expand the function of the data processing module by incorporating new processing units. In addition, if only a few types of data need to be processed, the data processing module may implement only one processing unit, wherein the processing unit may be used to process various types of audio data and audio metadata.

To facilitate query and management, audio metadata may be stored in Mysql databases by the database operation unit 421. To exceed the storage constraint of single memory machine, the audio data can be stored as audio files in NFS file systems by the file operation unit 420. In response to a search query, audio metadata in the database may checked for matching the search query and if a match is found in the database, a file including audio data associated with the matched audio metadata may be identified in the file system.

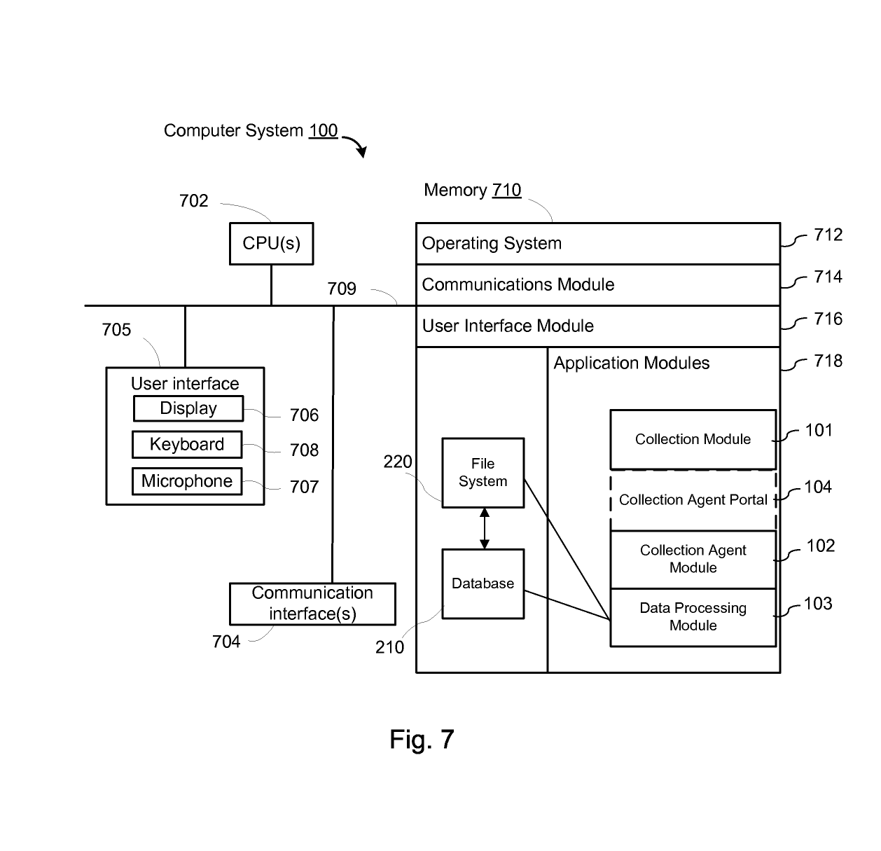

FIG. 7 illustrates the computer system that may be used to perform the methods described in FIGS. 5 and 6. To avoid redundancy, not all the details and variations described for the method are herein included for the computer system. Such details and variations should be considered included for the description of the devices as long as they are not in direct contradiction to the specific description provided for the methods.

FIG. 7 is a block diagram of a computer system in accordance with some embodiments of the present application. The exemplary computer system 100 typically includes one or more processing units (CPU's) 702, one or more network or other communications interfaces 704, memory 710, and one or more communication buses 709 for interconnecting these components. The communication buses 709 may include circuitry (sometimes called a chipset) that interconnects and controls communications between system components. The computer system 100 may include a user interface 705, for instance, a display 706, a keyboard 708, and a microphone 707. When the computer system 100 is a smart phone or tablet, the user interface 705 may include a touch screen, which is both a display and an input device. Memory 710 may include high speed random access memory and may also include non-volatile memory, such as one or more magnetic disk storage devices. Memory 710 may include mass storage that is remotely located from the CPU's 702. In some embodiments, memory 710 stores the following programs, modules and data structures, or a subset or superset thereof:
an operating system 712 that includes procedures for handling various basic system services and for performing hardware dependent tasks;
a network communication module 714 that is used for connecting the computer system 100 to the server, the computer systems, and/or other computers via one or more communication networks (wired or wireless), such as the Internet, other wide area networks, local area networks, metropolitan area networks, and so on;
a user interface module 716 configured to receive user inputs through the user interface 705;
and a number of application modules 718 including the following:
an audio signal collection module 101 configured to: receive audio data, process the audio data to generate audio metadata associated with the audio data, and transmit the audio data and the audio metadata;
an audio signal collection agent module 102 configured to: receive the audio data and the audio metadata, and generate a data queue of a fixed length using the audio data and the audio metadata by dropping data exceeding the fixed length; and
a data processing module 103 configured to process the data queue such that the audio metadata is stored in a database 210 and the audio data is stored in files within a file system 220 separate from the database, wherein, in response to a search query, audio metadata in the database 210 is checked for matching the search query and if a match is found in the database 210, a file including audio data associated with the matched audio metadata is identified in the file system 220;
and optionally, an audio signal collection agent portal 104 configured to: receive the audio data and the audio metadata from the audio signal collection module 101, and transmit the audio data and the audio metadata to the audio signal collection agent module 102.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for audio signal processing by a computer system, the method comprising:
at the computer system having one or more processors and memory storing programs executed by the one or more processors,
receiving audio data using an audio signal collection module;
processing the audio data to generate audio metadata associated with the audio data;
transmitting the audio data and the audio metadata to an audio signal collection agent module, wherein the audio signal collection agent module is configured to generate a data queue of a fixed length using the audio data and the audio metadata by dropping data exceeding the fixed length; and
processing the data queue using a data processing module such that the audio metadata is stored in a database and the audio data is stored in files within a file system separate from the database, wherein, in response to a search query, audio metadata in the database is checked for matching the search query and if a match is found in the database, a file including audio data associated with the matched audio metadata is identified.

2. The method of claim 1, wherein:
the step of transmitting the audio data and the audio metadata to the audio signal collection agent module comprises:
transmitting the audio data and the audio metadata to an agent portal, and
transmitting the audio data and the audio metadata from the agent portal to the audio signal collection agent module.

3. The method of claim 2, further comprising:
receiving collection instructions from the agent portal, wherein the audio data and audio metadata are transmitted based on the collection instructions.

4. The method of claim 3, wherein:
the collection instructions include: address information of the audio signal collection agent module, collection ratio for the audio data, and category information of the audio data.

5. The method of claim 1, wherein:
the audio data and the audio metadata are transmitted in the order of a receiving time succession of the audio data to the collection agent module, and
the data queue is formed based on the receiving time succession.

6. The method of claim 1, further comprising:
distributing the audio data and audio metadata to the data processing module from the data queue.

7. The method of claim 6, further comprising:
deleting the distributed audio data and audio metadata from the data queue.

8. The method of claim 1, wherein:
the audio signal collection module comprises multiple collection units, and
the computer system receives and processes the audio data using the multiple collection units.

9. A computer system comprising:
one or more processors;
memory; and
one or more programs modules stored in the memory and configured for execution by the one or more processors, the one or more program modules including:
an audio signal collection module configured to:
receive audio data,
process the audio data to generate audio metadata associated with the audio data, and
transmit the audio data and the audio metadata;
an audio signal collection agent module configured to:
receive the audio data and the audio metadata, and
generate a data queue of a fixed length using the audio data and the audio metadata by dropping data exceeding the fixed length; and
a data processing module configured to process the data queue such that the audio metadata is stored in a database and the audio data is stored in files within a file system separate from the database, wherein, in response to a search query, audio metadata in the database is checked for matching the search query and if a match is found in the database, a file including audio data associated with the matched audio metadata is identified.

10. The computer system of claim 9, further comprising an agent portal, wherein:
the agent portal is configured to:
receive the audio data and the audio metadata from the audio signal collection module, and
transmit the audio data and the audio metadata to the audio signal collection agent module.

11. The computer system of claim 10, wherein:
the audio signal collection module is configured to receive collection instructions from the agent portal, and
the audio data and audio metadata are transmitted based on the collection instructions.

12. The computer system of claim 9, wherein:
the agent portal is configured to transmit the audio data and the audio metadata in the order of a receiving time succession of the audio data to the collection agent module, and
the data queue is formed based on the receiving time succession.

13. The computer system of claim 9, wherein:
the audio signal collection agent module is configured to distribute the audio data and audio metadata to the data processing module from the data queue.

14. The computer system of claim 9, wherein:
the audio signal collection agent module is configured to delete the distributed audio data and audio metadata from the data queue.

15. The computer system of claim 9, wherein:
the audio signal collection module comprises multiple collection units, wherein the collection units are configured to receive and process the audio data.

16. A non-transitory computer readable storage medium having stored therein one or more instructions, which, when executed by a computer system, cause the computer system to:
receive audio data using an audio signal collection module;
process the audio data to generate audio metadata associated with the audio data;
transmit the audio data and the audio metadata to an audio signal collection agent module, wherein the audio signal collection agent module is configured to generate a data queue of a fixed length using the audio data and the audio metadata by dropping data exceeding the fixed length; and
process the data queue using a data processing module such that the audio metadata is stored in a database and the audio data is stored in files within a file system separate from the database, wherein, in response to a search query, audio metadata in the database is checked for matching the search query and if a match is found in the database, a file including audio data associated with the matched audio metadata is identified.

17. The non-transitory computer readable storage medium of claim 16, wherein the instructions further cause the computer system to:
transmit the audio data and the audio metadata to an agent portal, and
transmit the audio data and the audio metadata from the agent portal to the audio signal collection agent module.

18. The non-transitory computer readable storage medium of claim 16, wherein:
the audio data and the audio metadata are transmitted in the order of a receiving time succession of the audio data to the collection agent module, and
the data queue is formed based on the receiving time succession.

19. The non-transitory computer readable storage medium of claim 16, wherein the instructions further cause the computer system to:
distribute the audio data and audio metadata to the data processing module from the data queue.

20. The non-transitory computer readable storage medium of claim 16, wherein:
the audio signal collection module comprises multiple collection units, and
the instructions cause the computer system to receive and process the audio data using the multiple collection units.
